(19) United States
(12) Patent Application Publication
(10) Pub. No.: US 2025/0168684 A1
(43) Pub. Date: May 22, 2025

(54) SENSING IN NETWORKS

(71) Applicant: Nokia Technologies Oy, Espoo (FI)

(72) Inventors: Silvio MANDELLI, Tamm (DE); Ryan KEATING, Chicago, IL (US); Mark DOLL, Stuttgart (DE); Maximilian ARNOLD, Murrhardt (DE)

(21) Appl. No.: 18/840,960

(22) PCT Filed: Feb. 24, 2022
(86) PCT No.: PCT/EP2022/054676

§ 371 Date: Aug. 23, 2024

(51) Int. Cl. H04W 24/10; H04W 8/22; H04W 16/28; H04W 56/00

(52) U.S. Cl. CPC H04W 24/10; H04W 8/22; H04W 16/28; H04W 56/0015

(57) ABSTRACT

A method is disclosed including receiving a request for providing at least one of sensing capability information or sensing environment information; gathering, based at least in part on the request, at least one of the sensing capability information or sensing environment information; providing at least one of the gathered sensing capability hardware information or sensing environment information towards a central entity of a mobile communication network; and receiving an assignment for one or more sensing operations. It is further disclosed an according apparatus, computer program and system.

### FIELD

The following disclosure relates to the field of wireless networks, or more particularly relates to systems, apparatuses, and methods for performing (e.g. passive) sensing in mobile communication networks.

### BACKGROUND

The 5th generation (5G) of mobile communication drove the communication network to the physical performance bound regarding latency, throughput, and spectral efficiency. The next generation (e.g. 6G) extends this network further, converting communication networks to a joint physical-biological network. To achieve this, a controller can sense the state and behavior of each active and passive node/device/object within its environment. This is generally referred to as sensing. Thus, one of the key challenges for the next generation of wireless networks is to deliver sensing capabilities or operations. As these features or services require the same physical resource, many challenges arise, regarding sharing the resource, scheduling, and determining the quality of service of such sensing.

SUMMARY OF SOME EXEMPLARY EMBODIMENTS

In 6G network tomography scenarios, different devices would require procedures and standard signals to join their forces to acquire tomographic scans of the (e.g. radio) environment(s), allowing an entity to manage their sensing operations and/or to aggregate their measurements.

Organizing such heterogeneous and complex scenario is a challenging task. One requirement may be that an entity, which should manage/aggregate the information, has access to
the capabilities of the devices regarding their transceiver architecture;
the environmental properties in particular regarding the effective range and angle space the device can listen/scan.

Given the correlation among these two points, e.g. the range/angle space can be limited by the environment or the hardware, careful design of the best signals/settings e.g. to minimize overhead is beneficial. Further, allowing to optimize the mobile communication network by tuning a respective device configuration, e.g. based on directions where the communications and/or sensing should happen is beneficial. Then, the procedure may allow the aggregation of the information from multiple SAPs.

For convenience, a list of abbreviations used in the following is already given at this point:
3GPP 3rd Generation Partnership Project
5G Fifth generation
6G Sixth generation
AoA Angle of Arrival
AoD Azimuth of Departure
DL Downlink
GCS Global Coordinate System
gNB Next Generation Node B
HP Hard Priority
JCAS Joint Communication And Sensing
KPI Key Performance Indicator
LCS Local Coordinate System
LMF Location Management Function
MAC Medium Access Control (Layer)
NR New Radio
NRPPa NR Positioning Protocol A
OFDM Orthogonal Frequency Division Multiplexing
PHY Physical (Layer)
PoC Proof of Concept
PRS Positioning Reference Signal
QoS Quality of Service
Radar Radio detection and ranging
RAN Radio Access Network
RT Real Time
SAP Sensing Access Points (may be either JCAS base stations or (e.g. dedicated) UEs performing sensing)
SINR Signal to Interference plus Noise Ratio
SPS Semi-Persistent Scheduling
SRS Sounding Reference Signal
ToA Time of Arrival
TRP Transmission Reception Point
UE User Equipment
UL Uplink
XnAP Xn Application Protocol
ZoD Zenith of Departure

According to a first exemplary aspect, a method is disclosed, the method comprising:
receiving a request for providing at least one of sensing capability information or sensing environment information, wherein the sensing capability information is indicative of one or more capabilities related to at least one transceiver of an apparatus, and wherein the environment information is indicative of one or more properties of a radio environment of the apparatus;
gathering, based at least in part on the request, at least one of the sensing capability information or sensing environment information;
providing at least one of the gathered sensing capability information or sensing environment information towards a central entity of a mobile communication network; and
receiving an assignment for one or more sensing operations.

This method may for instance be performed and/or controlled by an/the apparatus, for instance a SAP (e.g. UE or JCAS base station), e.g. of a mobile communication network. The method may for instance be performed and/or controlled by an electronic device, e.g. a mobile terminal (e.g. the UE) or a sensing device. Such an electronic device may be represented by a SAP. For instance, the method may be performed and/or controlled by using at least one processor of the SAP.

Such an SAP (e.g. represented by an apparatus according to the first exemplary aspect as described above) will also be referred to as the apparatus according to the first exemplary aspect in the following.

It may be a UE of a cellular network (also referred to as mobile communication network), for instance a 3G, LTE/4G, 5G NR, 5G or 6G network. Further, it may be a mobile device, e.g. a handset, a smartphone, a tablet, a laptop, or any other mobile device. In various embodiments, it may be a vehicle for travelling in air, water, or on land, e.g. a plane or a drone, a ship or a car or a truck. It may also be a robot, a sensor device, a wearable device, an Internet of Things (IoT) device, a Machine Type Communication (TC) device, or the likes. Herewith and in the following, the term SAP, UE, and/or sensing device is used for such disclosed example apparatuses of the first exemplary aspect.

According to a further exemplary aspect, a computer program is disclosed, the computer program when executed by a processor causing an apparatus, for instance a server, to perform and/or control the actions of the method according to the first exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect, an apparatus is disclosed, configured to perform and/or control or comprising respective means for performing and/or controlling the method according to the first exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect, an apparatus is disclosed, comprising at least one processor and at least one memory including computer program code, the at least one memory and the computer program code configured to, with the at least one processor, cause an apparatus, for instance the apparatus, at least to perform and/or to control the method according to the first exemplary aspect.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise only the disclosed components, for instance means, processor, memory, or may further comprise one or more additional components.

According to a second exemplary aspect, a method is disclosed, the method comprising:
sending a request for providing at least one of sensing capability information or sensing environment information, wherein the sensing capability information is indicative of one or more capabilities related to at least one transceiver of a sensing device, and wherein the environment information is indicative of one or more properties of a radio environment of the sensing device;
obtaining at least one of the gathered sensing capability information or sensing environment information that were provided towards an apparatus;
determining an assignment of one or more sensing operations for the sensing device, wherein the assignment is determined based, at least in part, on the at least one of the gathered sensing capability information or sensing environment information; and
providing the determined assignment.

This method may for instance be performed and/or controlled by an/the apparatus, for instance a central entity (e.g. LMF), e.g. of a mobile communication network. The method may for instance be performed and/or controlled by a Server. Alternatively, this method may be performed and/or controlled by more than one apparatus, for instance a server cloud comprising at least two servers. Such a central entity may for instance be part of (e.g. hosted by) a respective server or server cloud. For instance, the method may be performed and/or controlled by using at least one processor of the central entity.

According to a further exemplary aspect, a computer program is disclosed, the computer program when executed by a processor causing an apparatus, for instance a server, to perform and/or control the actions of the method according to the second exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect, an apparatus is disclosed, configured to perform and/or control or comprising respective means for performing and/or controlling the method according to the second exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect, an apparatus is disclosed, comprising at least one processor and at least one memory including computer program code, the at least one memory and the computer program code configured to, with the at least one processor, cause an apparatus, for instance the apparatus, at least to perform and/or to control the method according to the second exemplary aspect.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise only the disclosed components, for instance means, processor, memory, or may further comprise one or more additional components.

According to a further exemplary aspect, a system is disclosed, comprising:

an apparatus according to the first exemplary aspect as disclosed above, and an apparatus according to the second exemplary aspect as disclosed above.

Any disclosure herein relating to any exemplary aspect is to be understood to be equally disclosed with respect to any subject-matter according to the respective exemplary aspect, e.g. relating to an apparatus, a method, a computer program, and a computer-readable medium. Thus, for instance, the disclosure of a method step shall also be considered as a disclosure of means for performing and/or configured to perform the respective method step. Likewise, the disclosure of means for performing and/or configured to perform a method step shall also be considered as a disclosure of the method step itself. The same holds for any passage describing at least one processor; and at least one memory including computer program code; the at least one memory and the computer program code configured to, with the at least one processor, cause an apparatus at least to perform a step.

In the following, exemplary features and exemplary embodiments of all aspects will be described in further detail.

Example embodiments of all exemplary aspects may allow one or more techniques (e.g. and/or in particular signaling) to properly handle multi-point passive radar-like sensing operations of apparatuses according to the first exemplary aspect are provided. This may be referred in this specification to sensing or sensing operation. In contrast to former 5G's active localization services, here gNBs or TRPs, hereafter referred to as SAP, are both transmitting a probing signal and receiving it to sense a passive environment. Thus, for efficiently selecting the most suitable probing signals in time/frequency/spatially, the respective SAP may need to know the capabilities of the transceiver hardware and the current state of the environment.

With regard to passive sensing, the ability of the (e.g. mobile) communication network to operate as a sort of pervasive radar, where the network scans the (e.g. radio) environment with one or more probing signals that can be received or observed (e.g. “heard”) by more SAPs, not only the one which is transmitting it is to be addressed. This may allow to construct a digital twin of the respective environment, as opposed to active localization services envisioned in 5G, where active UEs could
measure known Positioning Reference Signals' ToA and AoA in DL, or
send known reference signals in UL, e.g. SRS, to allow different SAPs to measure ToA and AoA, to determine their location.

Example embodiments enable that an aggregation of the ToA/AoA measures may be done at the SAP side (e.g. apparatus according to the first exemplary aspect) or at a central entity (e.g. LMF), e.g. by knowing one or more pieces of information about the UE, the transmitted signals and/or the gNB/TRPs location and orientation.

Further, future networks, e.g. 6G or Beyond 5G, may support legacy 5G's active localization procedures and their defined passive sensing operations, where a respective SAP (e.g. apparatus according to the first exemplary aspect) may also receive one or more signals transmitted by itself, e.g. equal to radar applications. Moreover, other SAPs (e.g. apparatuses according to the first exemplary aspect) may be allowed to gather (e.g. measure) signals emitted by a single SAP, allowing to extend the concept of network of radars to network tomography, with multiple (e.g. at least two) transmitters and receivers probing the same environment.

In order to get a good resolution/range of the sensed environment, high bandwidths/powers may be allocated to such sensing/radar scans to be performed by respective apparatuses of the first exemplary aspect. This may require operating in higher frequencies (e.g. having high overall bandwidth) and/or to leverage antenna arrays to achieve strong (e.g. directional) beamforming gains both at the transmitter and at the receiver.

Signaling between a respective apparatus of the first exemplary aspect and a respective apparatus of the second exemplary aspect may use NRPPa (or 6G equivalent), LPP (or 6G equivalent), or another new (e.g. future) sensing protocol, to name but a few non-limiting examples.

The request or providing at least one of sensing capability information or sensing environment information may equally be received e.g. via NRPPa (or 6G equivalent), LPP (or 6G equivalent), or another new sensing protocol signaling. The request may for instance be received from a central entity of the mobile communication network, e.g. an apparatus according to the second exemplary aspect.

The sensing capability information is indicative of one or more capabilities related to at least one transceiver, e.g. comprised by or connectable to the apparatus according to the first exemplary aspect. A respective sensing capability information may comprise or represent also information regarding software or parametrization, for instance total system bandwidth, that is given by a configuration and which may not be imposed by the hardware of the apparatus (e.g. apparatus of the first exemplary aspect) itself. Further, the sensing capability information may be indicative of a respective beam configuration or synchronization configured, activated and/or available at the apparatus according to the first exemplary aspect. This may allow to determine or tune a configuration to be activated by the respective SAPs.

The sensing environment information is indicative of one or more properties of a radio environment of the apparatus of the first exemplary aspect. The radio environment, as used herein, may be understood to be represented by one or more pieces of information of one or more objects (e.g. Object ID, Object) that may be a respective part or parts of the mobile communication network. Such parts may be active entities as UEs, base stations, SAPs, but also passive parts like obstacles, interferences, blockages, or environment changes, to name but a few non-limiting examples, which might influence an achievable performance of the mobile communication network. The sensing environment information may be indicative of one or more dynamic properties of the radio environment, e.g. comprising one or more of the information disclosed above.

Based at least in part on the request, the apparatus according to the first exemplary aspect may gather at least one of the sensing capability information or sensing environment information. The request may for instance indicate if the apparatus according to the first exemplary aspect should gather at least one of the sensing capability information or sensing environment information. The apparatus may for instance be configured e.g. by higher layer signaling to gather at least one of the sensing capability information or sensing environment information, and then, e.g. in the request, one or more trigger bits may initiate the gathering. In addition or in the alternative, the request may comprise information regarding whether to gather sensing capability information, or sensing environment information, or both. The gathering of at least one of the sensing capability information or sensing environment information may be a measurement of the respective pieces of information. The gathering may enable to extract a physical state of the radio environment in which the apparatus according to the first exemplary aspect may be located. The gathering may enable to extract a physical state of one or more capabilities, such as of at least one transceiver of the apparatus. For instance, number, panel ID, panel position of one or more antenna panels comprised by or connectable to the apparatus of the first exemplary aspect may be gathered.

After the gathering of at least one of the sensing capability information or sensing environment information, the respectively gathered sensing capability information and/or sensing environment information may be provided towards the central entity of the mobile communication network. The central entity may have sent the request for providing at least one of the sensing capability information or sensing environment information. The central entity may for instance be represented by an apparatus according to the second exemplary aspect. The expression “towards” may be understood that the apparatus of the first exemplary aspect may not be required to directly sent the gathered sensing capability in and/or sensing environment information to the central entity, but to another entity being different from the central entity which may then relay the sensing capability information and/or the sensing environment information to the central entity.

After the apparatus according to the first exemplary aspect has provided the at least one of the gathered sensing capability information or sensing environment information, the apparatus may receive an assignment for one or more sensing operations. A respective assignment may comprise a configuration for the apparatus to enable the apparatus of the first exemplary aspect to perform and/or control communication based on one or more directions where communications and/or sensing should occur For instance, the assignment may be a configuration with which e.g. a beamforming type or beam sweeping type (e.g. configuring the apparatus of the first exemplary aspect to transmit one or more beams in (e.g. all) pre-defined directions) can be configured so that certain sensing e.g. of the environment is enabled, to name but one non-limiting example. Such one or more sensing operations may enable the apparatus to perform and/or control passive sensing operations, where the respective apparatus according to the first exemplary aspect may also receive one or more signals transmitted by itself, and/or by other apparatuses according to the first exemplary aspect. This may further allow to gather (e.g. measure) signals emitted by a single apparatus, allowing to sense the mobile communication network's tomography, e.g. with multiple (e.g. at least two) transmitters and receivers probing the (e.g. same) radio environment.

Example embodiments of all exemplary aspects may thus enable passive sensing e.g. for next generation JCAS networks. The central entity's (e.g. LMF's) ability to manage such sensing operations, e.g. by providing the central entity information about one or more (e.g. each) SAPs and/or the environment. In particular, at least one of the following may be enabled:
The central entity may gather from (e.g. all) SAPs (access points and/or connected devices) information impacting their sensing capabilities (e.g. in the form of sensing capability information); and
The central entity may gather the current (e.g. radio) environment properties from (e.g. all) apparatuses according to the first exemplary aspect (e.g. in the form of sensing environment information).

Such sensing capability information and/or sensing environment information may be provided from both access points and UE (e.g. each being a SAP and thus, respective apparatuses of the first exemplary aspect, as used herein).

According to an exemplary embodiment of the first exemplary aspect, the gathering of the sensing capability information further comprises at least one of:
determining at least one beam configuration (e.g. of an antenna panel of the apparatus); or
determining at least one synchronization available or active at the apparatus.

As a part of the gathering of sensing capability information by the apparatus according to the first exemplary aspect, at least one beam configuration of the apparatus may be determined. The at least one beam configuration may represent a beam forming (e.g. type) active, or configured on part of the apparatus according to the first exemplary aspect. Further, as a part of the gathering of sensing capability information of the apparatus according to the first exemplary aspect, at least one synchronization available or active at the apparatus may be determined. This may allow to provide transceiver hardware information of the apparatus according to the first exemplary aspect. For instance, to fulfill e.g. future 3GPP standards, one or more capabilities about different antenna panels, possibly with different configurations/frequencies, that may be present in a respective apparatus according to the first exemplary aspect may be provided. For instance, antenna panels with the same or equal capabilities may be grouped in one TRP by a respective apparatus (e.g. SAP). More details about such parameter(s) respectively value(s) indicating the at least one beam configuration and/or the synchronization available are further disclosed below.

According to an exemplary embodiment of the first exemplary aspect, the gathering of the sensing environment information further comprises at least one of:
determining at least one load level of the apparatus in its serving cell;
determining at least one interference level of the apparatus; or
determining scenario dependent information indicative of one or more dynamic properties to which the apparatus is subject.

The at least one load level of the apparatus may be an indicator of a wireless resource utilization, in particular with regard to the maximum that is achievable given the respective hardware comprised by the apparatus of the first exemplary aspect. The at least one load level of the apparatus may be determined as a part of the gathering of sensing environment information. The at least one load level of the apparatus may be determined with regard to or in its (e.g. current) serving cell or its corresponding cell. The at least one load level of the apparatus may be determined in its (e.g. current) serving cell or its corresponding cell corresponding to a subset of one or more directions/beams of that cell.

Further, as a part of the gathering of sensing environment information, at least one interference level e.g. of one or more radio communications may be determined.

As another part of the gathering of sensing environment information, scenario dependent information may be determined. For instance, such scenario dependent information may comprise information about e.g. traffic, bandwidth, or a combination thereof which may be available on the apparatus.

Such a TRP information request, or environment update request may allow the central entity to request the apparatus according to the first exemplary aspect to provide detailed information for TRPs or to provide detailed information associated with TRPs, e.g. in the form of sensing environment information.

According to an exemplary embodiment of the first exemplary aspect, at least one of the TRP information request or the TRP information response is received or sent via ad-hoc messaging. The signaling may for instance be an ad-hoc messaging.

According to an exemplary embodiment of the second exemplary aspect, at least one of the TRP information request or the TRP information response is sent or received via ad-hoc messaging.

Further, using such TRP messaging may not (e.g. only) be required by the apparatus according to the first exemplary aspect, but also could be utilized by the request (e.g. message) issued by the central entity (e.g. LMF, e.g. represented by an apparatus according to the second exemplary aspect) to one or more apparatus according to the first exemplary aspect (e.g. UEs) that are attached to a respective cell, whose sensing activities may be controlled by the central entity.

According to an exemplary embodiment of the first exemplary aspect, the request is or is part of a Transmission Reception Point, TRP, information request or an environment update request.

According to an exemplary embodiment of the second exemplary aspect, the request is or is part of a Transmission Reception Point, TRP, information request or an environment update request.

According to an exemplary embodiment of the first exemplary aspect, at least one of the gathered sensing capability information or sensing environment information is provided via a Transmission Reception Point, TRP, information response.

According to an exemplary embodiment of the second exemplary aspect, at least one of the sensing capability information or sensing environment information is obtained via a Transmission Reception Point, TRP, information response.

The apparatus according to the first exemplary aspect may respond to a received information request or environment update request (e.g. message) with a TRP INFORMATION RESPONSE message that may comprise or contain at least one of the sensing capability or sensing environment information. The sensing capability and/or the sensing environment information may comprise or represent one or more information elements, e.g. in the form of one or more lists, an indicator of criticality (e.g. yes or no; 1 or 0).

According to an exemplary embodiment of the first exemplary aspect, the method further comprises: determining whether the apparatus supports or is configured to support the gathering of at least one of the sensing capability information or sensing environment information or not; and
in response to determining that the apparatus does not support the gathering of at least one of the sensing capability information or sensing environment information, providing a failure information.

The determining whether the apparatus supports or is configured to support the gathering of at least one of the sensing capability information or sensing environment information or not may be performed and/or controlled prior to the receiving of the request for providing at least one of sensing capability information or sensing environment information. The determining may be performed and/or controlled by a checking if e.g. one or more information elements as comprised by the request can be understood or interpreted correctly by the apparatus according to the first exemplary aspect. For instance, in case the request is a TRP INFORMATION REQUEST message containing TRP Information Type List having as a field “sensing hardware”, which may trigger a gathering of sensing capability information. If this information element cannot be understood, the request may be rejected by providing a failure information. Such a failure information may be provided as a TRP information failure message.

One or more of above or below mentioned information respectively information elements/fields may be requested via the central entity (e.g. apparatus according to the second exemplary aspect). Hereby, the respective central entity may receive a positive response on the request (e.g. the TRP information request), or a negative response in the form of a failure information, e.g. when the apparatus did not or cannot implement these capabilities in particular to perform and/or control one or more sensing operations.

According to an exemplary embodiment of the first exemplary aspect, the request comprises, at least a part of it, at least one of the following (e.g. information) fields associated with (e.g. related to or of) the sensing capability information:
a panel identifier of the apparatus;
at least one of a respective (e.g. one or more) panel position(s), orientation(s) or rotation(s) of at least one antenna panel of the apparatus;
a respective beamforming type supported by the apparatus;
a respective polarization supported by the apparatus;
a respective minimum azimuth value of at least one beam emittable by the apparatus;
a respective maximum azimuth value of at least one beam emittable by the apparatus;
a respective minimum elevation value of at least one at least one beam emittable by the apparatus;
a respective maximum elevation value of at least one at least one beam emittable by the apparatus;
a respective beamwidth per beam emittable by the apparatus;
at least one of one or more supported carrier frequencies, modes of operation (e.g. UL/DL), or bandwidths supported by the apparatus;
one or more update rates of beam patterns;
a respective receiver sensitivity of the apparatus;
a respective power consumption value of the apparatus;
a available energy information (e.g. total battery/energy, and/or remaining energy) of the apparatus; or
a synchronization confidence in one or more synchronizations available or active on part of the apparatus.

In case the request comprises at least one of these fields, this may indicate to the apparatus according to the first exemplary aspect to gather such respective field/element when it gathers the sensing capability information.

According, the provided sensing capability information may comprise, at least a part of it, at least one of these fields associated with (e.g. related to or of) the sensing capability information.

The one or more update rates of beam patterns may for instance be configured. Thus, the apparatus according to the first exemplary aspect may for instance be configured with such one or more update rates of beam patterns, e.g. by the apparatus according to the second exemplary aspect. For instance, the apparatus according to the first exemplary aspect may receive a respective configuration having at least an indication of the one or more update rates of beam patterns, and then the apparatus according to the first exemplary aspect may activate the respective configuration.

Such sensing capability information may be comprised in the form of information elements that may be related to one or more capabilities of the apparatus. The information listed above might not (e.g. all) be needed. Further, the information may not be required to be explicitly mentioned in the provided sensing capability information, but can in addition or in the alternative be indicated so that based on such an indication, the apparatus according to the second exemplary aspect may be enabled to determine the respective information, as disclosed above.

For instance, the TRP information request may be extended with one or more of the information. Also, one or more of the following information may be listable (e.g. in the form of lists) in the provided sensing capability information:
Panel Identifier of a respective antenna panel;
Panel positions and/or orientation/rotation of the respective antenna panel;
Beamforming type supported by the apparatus;
Polarization supported or (e.g. currently) activated by the apparatus;
Minimum and/or maximum azimuth value supported or (e.g. currently) activated by the apparatus;
Minimum and/or maximum elevation value supported or (e.g. currently) activated by the apparatus; and
Beamwidth per Beam supported or (e.g. currently) activated by the apparatus.

A respective panel identifier may be understood as a unique value to assign different tasks to the corresponding panel of the apparatus according to the first exemplary aspect. The corresponding “panel position” may give to a boresight a center of the respective antenna panel and its rotation e.g. in global coordinates (e.g. in the global coordination frame or format) to indicate the correct position. Since multiple panels may work together, in addition or in the alterative, relative position may be calculated. Thus, a general coordination framework may be beneficial. Further, the orientation may allow to derive the corresponding one or more angles (e.g. azimuth and/or elevation) in this framework.

A respective beamforming type may be understood as ranging from analog, hybrid to (e.g. fully) digital. This sensing capability information may allow to determine how much effort it is to e.g. scan a certain area, room or the like as comprised by the radio environment and/or how one or more (e.g. advanced) algorithms may be applied (e.g. clutter removal algorithms, which in digital may be different than in analog, to name but one non-limiting example). In case the beamforming type is hybrid, for instance, a/the number of digital chain(s) e.g. utilized by the apparatus according to the first exemplary aspect may be provided as a part of the sensing capability information.

Further, a respective polarization may be containing the horizontal, vertical and/or circular polarization type of the respective antenna. This may allow to minimize self-interference among different entities (e.g. apparatuses according to the first exemplary aspect) of the mobile communication network.

A respective minimum and maximum azimuth and/or elevation angle can be determined (e.g. derived) from a single antenna element pattern, e.g. patch, allowing to create a “visible” region field of view for a respective (e.g. each) panel, e.g. that is useable by the central entity (e.g. LMF) to plan potentially most efficient beam scan(s) when determining the respective assignment.

A respective beamwidth per beam may allow per beam to determine (e.g. decide) one or more interferences on one or more other entities as well as to understand which entity (e.g. other/further apparatuses of the first exemplary aspect) will be in the hearable or observable range of a probing signal, based on which such one or more sensing operations may then be enabled. A respective beamwidth per beam may in addition or in the alternative allow to determine a range resolution. A respective range resolution, as used herein, may be understood as a capability to separate one or more targets at close range. For instance, if the respective separation is larger than the resolution, such one or more targets can be separated with high confidence. Otherwise, it may become increasingly more difficult to separate such one or more targets.

A respective carrier frequency and/or a respective possible bandwidth (e.g. resulting from the antenna bandwidth) as well as a respective mode of operation at a specific carrier frequency may directly correspond to a respective path-loss of range accuracy.

Since a respective apparatus according to the first exemplary aspect (e.g. SAP) may comprise (e.g. contain or be connectable to) multiple (e.g. at least two) transceivers for multiple frequencies, a respective list of panels per transceiver (e.g. transceiver chain) may be beneficial. Further, from the transceiver hardware bandwidth and the DSP power, possible subcarrier spacing may be determined (e.g. derived). Further, a respective current beam pattern loaded (e.g. represented by a codebook name) and its possibility on updating the codebook may be determined. If no updating of providing of updated sensing capability information is allowed, the update rate may be set to infinity. Otherwise, the respective update rate may be indicated accordingly.

According to an exemplary embodiment of all exemplary aspects, in particular of the first exemplary aspect, the request comprises, at least a part of it, at least one of the following fields associated with (e.g. related to or of) the sensing environment information:
a respective (e.g. wireless resource) availability of one or more (e.g. transmission) resources;
a respective confidence of one or more detected reflectors;
one or more interference levels;
a respective blockage of a certain direction or beam;
a detected object information;
one or more environmental changes (e.g. of a/the radio environment; optionally with a/the direction or related beam(s)); or
a certain direction or range of one or more further devices (e.g. sensing devices, e.g. apparatuses according to the first exemplary aspect) for communication.

A respective mobility of the apparatus according to the first exemplary aspect may give a reliability regarding how to use the apparatus according to the first exemplary aspect (e.g. passive) sensing. For instance, users of a respective apparatus according to the first exemplary aspect, thus e.g. UEs as SAPs, may be used more as performing and/or controlling beacon (e.g. illumination) of the (e.g. radio) environment as a respective sensing operation. In this way, the respective receiver capabilities of the respective apparatus according to the first exemplary aspect will not be stressed. A respective power consumption information may allow to optimize regarding multiple apparatuses according to the first exemplary aspect (e.g. SAPs) a power efficiency to handle infrastructure scans. Here, users of such UEs should not be burdened too much.

As a respective synchronization confidence may enable to select which combination(s) of apparatuses according to the first exemplary aspect (e.g. SAPs) can work together, an information (e.g. information field) regarding to which respective apparatus (e.g. SAP) which synchronization is active may be provided. A respective assignment may then in response coordinate such synchronization to be applied. This may comprise e.g. time synchronization over PTP or NTP, clock and/or phase synchronization over white rabbit, other techniques, or a combination thereof to name but a few non-limiting examples.

Such a synchronization may be defined (e.g. set) to the accuracy in time/phase given in e.g. nanoseconds as standard deviation and/or degrees/or a respective stability over time as an integer value. Further, this information may be extended by a list comprising or containing to which apparatus(es) according to the first exemplary aspect (e.g. SAPs) the synchronization holds. If such a list is empty, this synchronization may be interpreted according to a global reference system, e.g. as a default case.

A respective blockage of a certain direction or beam, and/or a detected object information may represent e.g. objects considered static, and/or known to the central entity (e.g. apparatus according to the second exemplary aspect) a-priori e.g. due to sensing from one or more other SAPs (e.g. apparatus(es) according to the first exemplary aspect). In particular based on at least one of a respective blockage of a certain direction or beam, or a detected object information, the central entity may be enabled to perform and/or control clutter removal.

In case the request comprises at least one of these fields referring to sensing environment information, this may indicate to the apparatus according to the first exemplary aspect to gather such respective field/element when gathering the sensing environment information.

Accordingly, the provided sensing environment information may comprise, at least a part of it, at least one of these fields associated with (e.g. related to or of) the sensing environment information.

Such sensing environment information may be comprised in the form of information elements that may be related to the radio environment of (e.g. surrounding, e.g. within a pre-defined diameter) the apparatus. The information listed above might not (e.g. all) be needed. Further, the information may not be required to be explicitly mentioned in the provided sensing environment information, but can in addition or in the alternative be indicated so that based on such an indication, the apparatus according to the second exemplary aspect may be enabled to determine the certain information, e.g. based on a look-up table to name but one non-limiting example.

Wireless resource availability may be beneficial for the central entity (e.g. LMF) to know which apparatus according to the first exemplary aspect (e.g. SAP) can be leveraged to use sensing scans or is too loaded from communication.

A respective detected object information may for instance comprise information about or associated with one or more detected (e.g. physical) objects that may then be shared by the central entity to other SAP(s) e.g. to enhance their clutter removal algorithms. A respective stability may be determined (e.g.

calculated) by the confidence and the speed of such objects. Thus, the respective objects of the radio environment with a high confidence and zero speed are marked as infrastructure and be used in the clutter removal algorithms. The type may be as follows: anything that may be capable of sensing, e.g. human, car, or the like to name but a few non-limiting examples. Further, the status may allow to flag one or more (e.g. detected) objects as malfunctioning, or an anomaly may be detected and then indicated.

Further, range, angular, speed confidence map may be determined. This may for instance be done at least in part on the respective detected object information. Therein, objects “hearable” or observable at a respective SAP may be aggregated. Per object, at least one of the following information can be shared via such a map:
Position;
Dimension(s);
status;
shape/type;
rotation;
speed (e.g. and/or stability); or
confidence.

A respective range, angular, and/or speed confidence map may be determined based e.g. on a processing of raw sensing environment information. Such raw sensing environment information may comprise, among other things, raw amplitude/phase corresponding to (e.g. each) range/speed/angle detectable, e.g. about the environment. Such information that can be shared (e.g. obtained by the apparatus of the second exemplary aspect; provided by the apparatus of the first exemplary aspect) via a respective map may be aggregated to, e.g., determine (e.g. detect) one or more objects and their characteristics.

One or more interference levels may be measured at a respective apparatus according to the first exemplary aspect. This may allow to depict a quality of sensing possibilities, since such an understanding that interference will strongly limit the sensing abilities for performing and/or controlling one or more sensing operations, while communication that still is possible. This may enable the apparatus according to the second exemplary aspect to determine adequate assignment(s) of one or more sensing operations for the respective apparatus of the first exemplary aspect.

A respective blockage may determine if temperature/humidity/strong reflector and/or other environmental factors may currently limit a performance of the respective apparatus of the first exemplary aspect. Blockage may not be static, but may also be a periodic information/signal provided.

As a Boolean value, e.g. drastic environmental changes may be used to update range/angular stability of a reflector map. Direction/range of communication devices (e.g. may be SAPs) may be re-used for sending as those scans will be done anyhow for communications, e.g. communication signals can be re-used as (e.g. only) a respective transmission signal is required, and not underlying data.

According to an exemplary embodiment of the first exemplary aspect, wherein the method further comprises:
performing, based on the received assignment, the one or more sensing operations; and
providing information indicative of one or more results of at least one performed sensing operation of the one or more sensing operations.

According to an exemplary embodiment of the first exemplary aspect, a respective assignment comprises at least one of a probing sensing operation, a responding to a probing sensing operation, an interworking with another sensing device probing operation.

A respective probing sensing operation, a respective responding to a probing sensing operation, and/or a respective interworking with another sensing device probing operation may be managed by the apparatus of the second exemplary aspect. When such an assignment is received by the apparatus of the first exemplary aspect, the respective sensing operation may be performed and/or controlled.

A respective probing sensing operation may trigger the apparatus according to the first exemplary aspect to provide (e.g. sent or emitted) a respective probing signal. Here, the apparatus according to the first exemplary aspect may allow other apparatuses (e.g. SAPs) of the first exemplary aspect to measure such a probing signal emitted by the apparatus of the first exemplary aspect.

A respective responding to a probing sensing operation may trigger the apparatus according to the first exemplary aspect to gather (e.g. measure) one or more probing signals provided (e.g. sent or emitted) by one or more other apparatuses (e.g. SAPs) according to the first exemplary aspect. Further, a response to the gathered probing signal may be provided (e.g. sent) towards the one or more other apparatuses (e.g. SAPs) according to the first exemplary aspect that provided the probing signal.

A respective interworking with another sensing device (e.g. SAP; apparatus according to the first exemplary aspect) probing operation may trigger the apparatus according to the first exemplary aspect to perform probing of the (e.g. radio) environment together with one or more other apparatuses (e.g. SAPs) according to the first exemplary aspect. For instance, via such an assignment, the apparatus according to the first exemplary aspect may receive an identifier to enable e.g. to establish a connection to another apparatus (e.g. SAP) according to the first exemplary aspect so that the interworking may be performed and/or controlled. For instance, for clutter removal, the assignment may comprise aspect(s) of the environment (e.g. one or more objects considered static, known to the apparatus according to the second exemplary aspect) e.g. a-priori of due to sensing from one or more other SAPs (e.g. one or more apparatuses according to the first exemplary aspect). Thus, a respective interworking with another sensing device or a plurality (e.g. at least two) other sensing devices probing operation may comprised or be accompanied by such aspect(s) of the environment enabling to perform and/or control clutter removal.

According to an exemplary embodiment of the second exemplary aspect, the method further comprises:
determining one or more sensing devices enabled to provide, at least partially jointly, at least one of one or more range estimates, angular estimates, speed estimates or object's shape estimates.

Such one or more range estimates, angular estimates, and/or speed estimates may for instance be estimates within which-in the communication network-communication is enabled as a sensing operation.

According to an exemplary embodiment of the first exemplary aspect, the method further comprises:
providing information indicative of one or more results of at least one sensing operation towards the central entity.

According to an exemplary embodiment of the second exemplary aspect, the method further comprises:
obtaining information indicative of one or more results of at least one sensing operation performed by at least one sensing device.

According to an exemplary embodiment of the second exemplary aspect, the method further comprises:
weighting at least one of the sensing capability information or sensing environment information received, e.g. when aggregating information by multiple sensing devices (e.g. SAPs), wherein the aggregating is performed and/or controlled based, at least in part on the range/speed/angular confidence of the corresponding sensing device, based on its hardware/environmental capabilities as comprised by the at least one of the sensing capability information or sensing environment information.

According to an exemplary embodiment of the first exemplary aspect, the apparatus (e.g. performing and/or controlling the method of the first exemplary aspect) is a radio access network, RAN, node of a mobile communication network, a sensing access point, SAP, or a user equipment, UE, supporting sensing.

Example embodiments of all exemplary aspect may be established for any generic SAP, including also e.g. UEs that may be managed by the central entity (e.g. a LMF).

Corresponding to the receiving of the request that is performed and/or controlled by the apparatus of the first exemplary aspect, the apparatus of the second exemplary aspect sends the request for providing at least one of sensing capability information or sensing environment information. Then, e.g. in response to the provided (e.g. sent) request, at least one of the gathered sensing capability information or sensing environment information that were provided (e.g. sent, e.g. by the apparatus of the first exemplary aspect that received the request) towards the apparatus are obtained, e.g. by receiving at least one of the gathered sensing capability information or sensing environment information. Such a request may be sent to a plurality (e.g. at least two) of apparatuses (e.g. SAPs) according to the first exemplary aspect. Thus, also a plurality (e.g. at least two) of at least one of gathered sensing capability information or sensing environment information may be obtained, e.g. in response. This may allow the apparatus according to the second exemplary aspect to determine the respective assignment based on or considering, at least in part, the plurality of obtained pieces of sensing capability information and/or sensing environment information. The assignment may further be determined based on other information, e.g. information already available on part of the apparatus according to the second exemplary aspect. For instance, such other information may comprise a location of the respective SAP (e.g. apparatus according to the first exemplary aspect) from which the apparatus according to the second exemplary aspect obtained at least one of the gathered sensing capability information or sensing environment information, to name but one non-limiting example. Then, respective one or more determined assignments can be provided (e.g. back) to the respective plurality of apparatuses (e.g. SAPs) of the first exemplary aspect from which the one or more pieces of sensing capability information and/or sensing environment information were obtained.

After the apparatus according to the first exemplary aspect has provided the at least one of the gathered sensing capability information or sensing environment information, the apparatus according to the second exemplary aspect will be able to known e.g. which beam configuration and synchronization is available at the apparatus according to the first exemplary aspect to decide which apparatus according to the first exemplary aspect can e.g. scan a certain part of the environment. For this, the apparatus according to the second exemplary aspect may determine and then provide a corresponding assignment of such a sensing operation to the apparatus according to the first exemplary aspect. Therefore, example embodiments of all exemplary aspect may allow to share e.g. sending capability information and/or sensing environment information about the available beams and their properties as well as their synchronization capabilities.

After the apparatus according to the first exemplary aspect has provided sensing environment information, the dynamic properties of the (e.g. radio) environment may be known by the apparatus according to the second exemplary aspect. This may allow the apparatus according to the second exemplary aspect to optimize update scans. Regarding synchronization, this may also allow (e.g. for the first time) to decide which apparatus according to the first exemplary aspect can work together to provide range estimates and/or to determine a respective (e.g. synchronization) confidence in one or more synchronizations available or active on part of the respective apparatus(es) according to the first exemplary aspect. To achieve this, the apparatus according to the second exemplary aspect may determine and provide a respective assignment to one or more apparatuses of the first exemplary aspect so that such a sensing operation to derive one or more range estimates can be performed and/or controlled.

A straightforward way to transmit raw channel may overload the apparatus according to the second exemplary aspect. Thus, a compressed sharing of obtained sensing environmental information may be beneficial.

According to an exemplary embodiment of the second exemplary aspect, wherein the method further comprises:
merging at least one of a plurality of pieces of sensing capability information or sensing environment information obtained from a plurality of sensing devices, wherein the assignment for a respective sensing device (e.g. of the plurality of sensing devices (e.g. apparatuses according to the first exemplary aspect) is determined further based on the merged at least one of one or more pieces of sensing capability information or sensing environment information.

This may allow to provision sensing operation(s), e.g. via an assignment, based on the merging of the sensing capabilities/environment. For instance, the assignment may comprise compressed sensing environment information as obtained by the apparatus of the second exemplary aspect so that via the assignment, one or more (e.g. further) apparatuses of the first exemplary aspect can get knowledge about the radio environment by the received assignment comprising such compressed information.

For this, the sensing environment information may be merged at the central entity (e.g. LMF).

For complex network tomography scans, different entities of the mobile communication network may work hand in hand, e.g. by being managed by the central entity (e.g. a LMF). Thus, such a central entity may require the knowledge on which SAP (e.g. UE and/or access point and/or JCAS base station) can provide a certain environmental scan with the highest accuracy by knowing their beamforming capabilities, impacting angular and range estimation performance, respectively. The central entity may be provided with at least one of sensing capability information or sensing environment information of a plurality (e.g. at least two) of apparatuses according to the first exemplary aspect. Such information may be merged, e.g. to determine how certain SAPs which provided at least one of sensing capability information or sensing environment information can word hand in hand to scan e.g. a complex network tomography as a respective sensing operation.

Further, the central entity may need to know interference level(s) at the different SAP to not use interference heavy SAP or (e.g. only) in crucial situations, which may be provided to the central entity via the sensing environment information. This may enable another possible application to offload scans to less loaded access points (or SAPs), increasing both their update rate and improving the communication throughput. This may allow sharing (e.g. each) SAP capabilities and the generic environmental properties to the central entity (e.g. LMF).

According to an exemplary embodiment of the second exemplary aspect, the apparatus (e.g. performing and/or controlling the method of the second exemplary aspect) is a central entity (e.g. a LMF) of the mobile communication network (e.g. of a core network of the mobile communication network).

The features and example embodiments described above may equally pertain to the different aspects.

It is to be understood that the presentation in this section is merely by way of examples and non-limiting.

Other features will become apparent from the following detailed description considered in conjunction with the accompanying drawings. It is to be understood, however, that the drawings are designed solely for purposes of illustration and not as a definition of the limits, for which reference should be made to the appended claims. It should be further understood that the drawings are not drawn to scale and that they are merely intended to conceptually illustrate the structures and procedures described herein.

### BRIEF DESCRIPTION OF THE DRAWINGS

The figures show:

FIG. 1 a schematic block diagram of a system according to an exemplary aspect;

FIG. 2 a flowchart showing an example embodiment of a method according to the first exemplary aspect;

FIG. 3 a flowchart showing an example embodiment of a method according to the second exemplary aspect;

FIG. 4a, b a signaling flowchart showing an example embodiment of all exemplary aspects;

FIG. 5a-d a signaling flowchart showing an example embodiment of all exemplary aspects; and

FIG. 6 a schematic block diagram of an apparatus configured to perform the method according to at least one of the first or second exemplary aspect.

### DETAILED DESCRIPTION OF SOME EXEMPLARY EMBODIMENTS

The following description serves to deepen the understanding and shall be understood to complement and be read together with the description as provided in the above summary section of this specification.

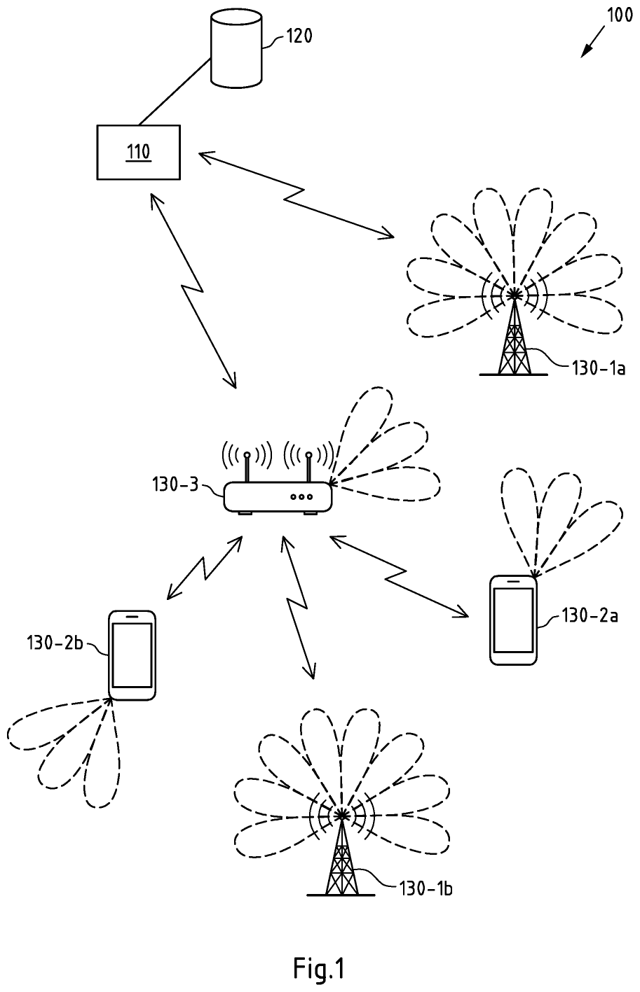

FIG. 1 is a schematic high-level block diagram of a system 100 according to all exemplary aspects. System 100 comprises one or more apparatuses 130 representing e.g. apparatuses according to the first exemplary aspect, and another apparatus 110 representing e.g. an apparatus according to the second exemplary aspect. The apparatuses 130 and the apparatus 110 may for instance be part of a mobile communication network.

Apparatuses 130-1a and 130-1b may for instance be a respective JCAS base station. Apparatuses 130-2a and 130-2b may for instance be respective UEs. Apparatus 130-3 may for instance be an access point. In general, apparatuses 130-1a, 130-1b, 130-2a, 130-2b and 130-3 may be referred to as SAPs. Apparatus 110 may for instance be a central entity (e.g. of a core network) of the mobile communication network. For instance, apparatus 110 may be a LMF of a mobile communication network. Apparatus 110 may be or be hosted by a server providing services for the mobile communication network. Apparatus 110 may be represented by such a single server. Alternatively, apparatus 110 may be part of a server cloud, e.g. comprising at least two servers and which may provide one or more services for the mobile communication network at least partially jointly.

Database 120 is optional. Database 120 may for instance be comprised by or be connectable to apparatus 110. Database 120 may provide a memory for storing data, e.g. one or more pieces of sensing capability information, one or more pieces of sensing environment information, one or more sensing operations, one or more pieces of assignments, or a combination thereof, to name but a few non-limiting examples.

The arrows illustrated between the shown entities in FIG. 1 represent communication that may occur between the entities. Further, the beam pattern illustrated at the apparatus 130-1a, 130-1b, 130-2a, 130-2b and 130-3 show that beam forming and/or beam sweeping may be utilized by the respective apparatus. This may allow e.g. to perform and/or control passive sensing in the mobile communication network by the apparatuses 130-1a, 130-1b, 130-2a, 130-2b and 130-3.

System 100 may represent a generic architecture enabling to perform and/or control example embodiments of all exemplary aspects.

Example embodiments of all exemplary aspects may provide a family of procedure(s) and standard enhancement(s) e.g. for such a mobile communication network, e.g. a next generation JCAS network (e.g. 6G or above standard). The LMF's (e.g. apparatus 110) ability to manage one or more sensing operations, e.g. by providing with information about one or more (e.g. each) SAPs (e.g. apparatuses 130) and/or a radio environment surrounding the respective SAPs. This may be done e.g. with an ad-hoc messaging. In particular, at least one of the following is enabled:
The LMF (e.g. apparatus 110) may obtain (e.g. receive) or gather from (e.g. all) SAPs (base stations and/or access points and/or connected devices; e.g. apparatuses 130) information impacting their sensing capabilities (Hardware information, e.g. sensing capability information); and/or
The LMF may obtain (e.g. receive) or gather current environment properties from (e.g. all) SAPs (Environmental information, e.g. in the form of sensing environment information).

Based, at least in part, on at least one of obtained sensing capability information or sensing environment information, the LMF 110 may determine an assignment of one or more sensing operations, and may provide a respective assignment to at least one of the apparatuses 130.

The sensing capability information and/or the sensing environment information may be obtained by the apparatus 110, e.g. by receiving them from one or more of the apparatuses 130. The sensing capability information and/or the sensing environment information may be received directly from the respective apparatus of the apparatuses 130, or indirectly, wherein a respective sensing capability information and/or the sensing environment information may be sent via one or more entities (e.g. by forwarding them) towards the apparatus 110.

1. Collecting Hardware Information (e.g. Obtaining Sensing Capability Information):

This may allow to obtain or gather (e.g. all) hardware (or capability) information required to extract a physical state of the (e.g. radio) environment, e.g. from the apparatuses 130. In addition or in the alternative to already exchanged information, the LMF (e.g. apparatus 110) will be able to known which beam configuration and/or synchronization is available at the respective SAP (e.g. one of the apparatuses 130) that provided the respective sensing capability information e.g. to decide which SAP can scan a certain part of the environment (e.g. of the mobile communication network, e.g. a cell of the mobile communication network). Therefore, a procedure allowing to share (sensing capability) information e.g. about the available beams and their properties as well as their synchronization capabilities may be beneficial. This may allow the one or more of the apparatuses 130 to provide such sensing capability information towards the apparatus 110.

Note that the hardware information (e.g. sensing capability information) may be possible to be collected (e.g. obtained by the apparatus 110) e.g. from both access points (e.g. apparatus 130) and devices (e.g. apparatus 130-2a and 130-2b). Such access points and such devices may be or represent a respective SAP.

2. Collecting Environmental Information (e.g. Obtaining Sensing Environment Information):

As the collecting of hardware information (e.g. sensing capability information) may share information about a respective (e.g. each) transceiver capabilities, another procedure may enable to share a/the current load, a/the interference level and other scenario dependent information which may be required. This procedure may share dynamic properties of the environment (e.g. of the mobile communication network), e.g. allowing to optimize update scans. Regarding synchronization, this procedure(s) may allow (e.g. for the first time) to decide which SAP (e.g. apparatuses 130) can work together e.g. to provide range estimate(s). As a/the straightforward way to transmit raw channel (e.g. information) may overload the LMF (e.g. apparatus 110), a compressed sharing of the environmental information (e.g. sensing environment information) may be enabled:

Example embodiments of all exemplary aspects may allow to provide environmental information (e.g. sensing environment information from a respective SAP towards the LMF). It may be enabled to share the sensing environment information to the LMF gathered at the SAPs and devices. An extension of the SAP message envisioned containing one or more of the fields of:
wireless resources availability (e.g. load in a respective serving cell of the respective SAP);
confidence of each detected reflectors (objects);
interference levels at the receiver sides;
(optional) blockage of a certain direction/beam;
(optional) environmental changes with optionally the direction or beam related; and
(optional) Direction/Range of devices for communication

For complex network tomography scans (e.g. of the respective environment), e.g. different entities (e.g. apparatuses 130) may work hand in hand, by being managed by a/the central entity (e.g. a LMF, such as apparatus 110). Thus, such a central entity (e.g. apparatus 110) may require knowledge on which SAP/UE (e.g. one of the apparatuses 130) can provide a certain environmental scan (e.g. in the form of provided sensing environment information), e.g. with the highest accuracy. This may be enabled by knowing their respective beamforming capabilities, impacting angular and range estimation performance, respectively, to name but a few non-limiting examples.

In this way, a method and signaling to provide sensing capabilities and environment information (e.g. in the form of at least one of sensing capability information or sensing environment information) is provided.

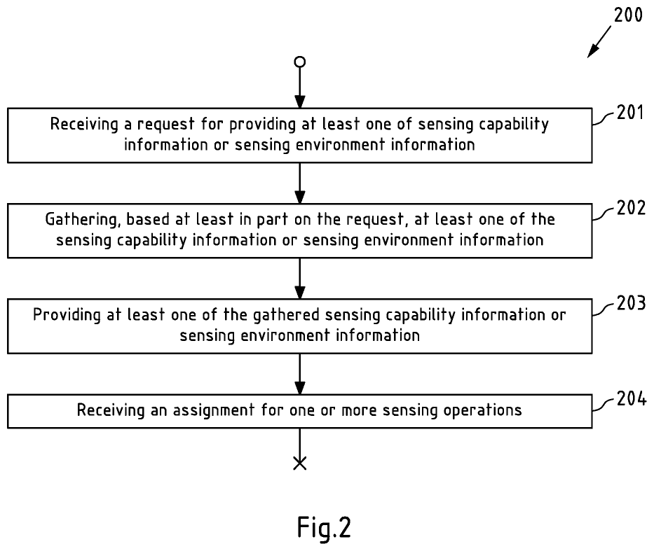

FIG. 2 is a flowchart 200 showing an example embodiment of a method according to the first exemplary aspect. This flowchart 200 may for instance be performed by at least one of the apparatuses 130-1a and 130-1b which may represent a respective JCAS base station. Additionally or alternatively, flowchart 200 may be performed by at least one of the apparatuses 130-2a and 130-2b which may for instance represent a respective UE. Additionally or alternatively, flowchart 200 may be performed by apparatus 130-3 which may for instance represent an access point. of FIG. 1.

In a first step 201, a request for providing at least one of sensing capability information or sensing environment information is received. The request may be received from an apparatus according to the second exemplary aspect. The sensing capability information is indicative of one or more, in particular transceiver capabilities related to at least one transceiver of a respective apparatus (e.g. according to the first exemplary aspect. The sensing environment information is indicative of one or more (e.g. dynamic) properties of a radio environment of (e.g. surrounding) the apparatus performing and/or controlling flowchart 200.

In a second step 202, based at least in part on the request received in step 201, at least one of the sensing capability information or sensing environment information are gathered (e.g. measured). For instance, at least one of the sensing capability information or sensing environment information may be gathered by determining the respective sensing capability information or the sensing environment information. The apparatus performing and/or controlling the flowchart 200 may for instance utilize its one or more transceivers to gather (e.g. measure) the sensing capability information and/or the sensing environment information. Whether the apparatus performing and/or controlling the flowchart 200 gathers sensing capability information, sensing environment information, or both sensing capability information and sensing environment information may be comprised by or be indicated in the request received in step 201.

In a third step 203, at least one of the gathered sensing capability information or sensing environment information is provided towards a central entity of a mobile communication network. Such a central entity may be an apparatus according to the second exemplary aspect. The request received in step 201 may for instance stem from such a central entity. At least one of the sensing capability information or sensing environment information gathered in step 202, may be provided towards the central entity, e.g. by sending the gathered sensing capability information or sensing environment information directly to the central entity. This may be done in case the apparatus performing and/or controlling the flowchart 200 may have a direct communication connection established between the apparatus and the central entity. Additionally or alternatively, the at least one of the gathered sensing capability information or sensing environment information is provided towards the central entity by the apparatus performing and/or controlling the flowchart 200 sending at least one of the gathered sensing capability information or sensing environment information to an entity (e.g. comprised by the mobile communication network that also comprises the central entity) which may then relay or forward at least one of the gathered sensing capability information or sensing environment information to the central entity. This may be done in case the entity has a connection established to the central entity.

Otherwise, the entity may for instance further relay or forward to another entity e.g. comprised by the mobile communication network that also comprises the central entity) which then may relay or forward at least one of the gathered sensing capability information or sensing environment information to the central entity and so on until the central entity received the at least one of the gathered sensing capability information or sensing environment information. In this way, at least one of the gathered sensing capability information or sensing environment information may be provided towards the central entity.

In a fourth step, an assignment for one or more sensing operations is received. The assignment may be received in response to the providing of at least one of the gathered sensing capability information or the sensing environment information. By such a received assignment, the central entity (e.g. apparatus according to the second exemplary aspect) may trigger or configure the apparatus according to the first exemplary aspect to perform and/or control one or more sensing operations. For instance, the apparatus according to the first exemplary aspect performing and/or controlling the flowchart 200 may receive the assignment. By the assignment, the apparatus performing and/or controlling the flowchart 200 may be triggered or instructed to perform a scan, e.g. optimized update scan of the environment. The assignment may for instance configure the apparatus performing and/or controlling the flowchart 200 to utilize beam sweeping to perform the one or more sensing operations. Further, the assignment, if a respective counterpart of an assignment is provided to one or more other apparatuses according to the first exemplary aspect respectively performing and/or controlling the flowchart 200, such apparatuses may work together to perform a respective scanning (e.g. gathering sensing environment information), e.g. to determine range estimates, to name but one non-limiting example. Such one or more sensing operations may be optimized since the apparatus performing and/or controlling the flowchart 200 has provided e.g. its sensing capability information enabling a/the central entity to coordinate optimized scanning of the mobile communication network, to name but one non-limiting example.

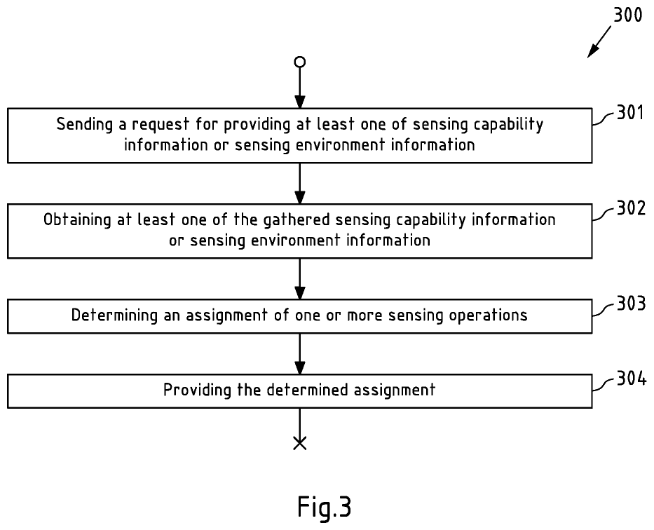

FIG. 3 is a flowchart 300 showing an example embodiment of a method according to the second exemplary aspect. This flowchart 300 may for instance be performed by apparatus 110 of FIG. 1. Additionally or alternatively, flowchart 300 may be performed by a central entity (e.g. a LMF) of a mobile communication network.

In a first step 301, a request for providing at least one of sensing capability information or sensing environment information is provided, e.g. by sending it to an apparatus according to the first exemplary aspect (e.g. one of the apparatuses 130 of FIG. 1). The request may then be received by such an apparatus according to the first exemplary aspect (see step 201 of FIG. 2).

In a second step 302, e.g. in response to the providing of the request of step 301, the at least one of the gathered sensing capability information or sensing environment information that were provided towards the apparatus performing and/or controlling the flowchart 300 is obtained, e.g. by receiving at least one of the gathered sensing capability information or sensing environment information. The at least one of the gathered sensing capability information or sensing environment information may then be obtained (e.g. received) since an apparatus performing and/or controlling the flowchart 200 of FIG. 2 may have provided them (see step 203 of FIG. 2).

In a third step 303, in particular based on a plurality of sensing capability information and/or sensing environment information obtained in step 302 e.g. from a plurality of apparatuses (e.g. respectively performing and/or controlling the flowchart 200 of FIG. 2), an assignment indicative of one or more sensing operations to be performed and/or controlled by a respective apparatus from which at least one of the gathered sensing capability information or sensing environment information in step 302 were obtained, is determined. The assignment is determined based, at least in part, on the at least one of the gathered sensing capability information or sensing environment information of step 302.

Then, in a fourth step 304, the determined assignment of step 303 is provided. The assignment may be provided, e.g. by higher layer signaling or dedicated control signaling, to name but a few non-limiting examples.

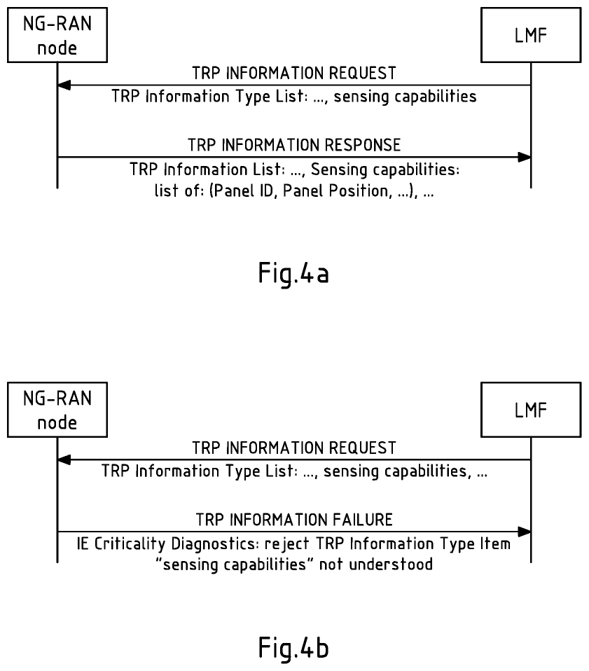

FIG. 4a, b each show a signaling flowchart showing an example embodiment of all exemplary aspects. In FIG. 4a, b, the NG-RAN node may for instance be represented by an apparatus according to the first exemplary aspect. Further, in FIG. 4a, b, the LMF may for instance be represented by an apparatus according to the second exemplary aspect.

In FIG. 4a, via a TRP INFORMATION REQUEST message representing a disclosed request, the LMF may request the providing of at least one of sensing capability information or sensing environment information from the NG-RAN node. The TRP INFORMATION REQUEST message may comprise or be indicative of sensing capabilities (e.g. sensing hardware) as requested sensing capability information. Such sensing capability information may be requested by a TRP Information Type List having the field “sensing capabilities” as one of its options set or defined.

In response to the received TRP INFORMATION REQUEST message, the NG-RAN node may provide a TRP INFORMATION RESPONSE message. This message may comprise or be indicative of a certain TRP Information List. By such a TRP Information List, the NG-RAN node may be enabled to provide one or more of its sensing capability information, e.g. of its sensing capabilities (e.g. sensing hardware) e.g. by a list of: e.g. antenna panel ID, antenna panel position, to name but a few non-limiting examples. Such a list may comprise or be indicative of one or more of the features disclosed above in the summary section with regard to the sensing capability information and/or sensing environment information. However, FIG. 4a shows the requesting of sensing capability information.

In FIG. 4b, via a TRP INFORMATION REQUEST message representing a disclosed request, the LMF may request the providing of at least one of sensing capability information or sensing environment information from the NG-RAN node. However, the NG-RAN node may not be enabled to provide its sensing capability information. Therefore, in response to the received TRP INFORMATION REQUEST message, the NG-RAN node may provide a TRP INFORMATION FAILURE message. With such a TRP INFORMATION FAILURE, the NG-RAN node may reject the TRP INFORMATION REQUEST message.

Thus, in FIG. 4a, the LMF receives a positive response on the TRP INFORMATION REQUEST message, and in FIG. 4b, the LMF receives a failure request, when the NG-RAN node (e.g. sensing device, SAP) did not have e.g. one or more sensing capabilities implemented which may allow the respective NG-RAN node to be a suitable a candidate to perform and/or control one or more sensing operations as disclosed above in the summary section.

Further, this may not (e.g. only) be required by the SAP, but also could be a request message from the central entity (e.g. LMF) to one or more attached devices (e.g. UEs).

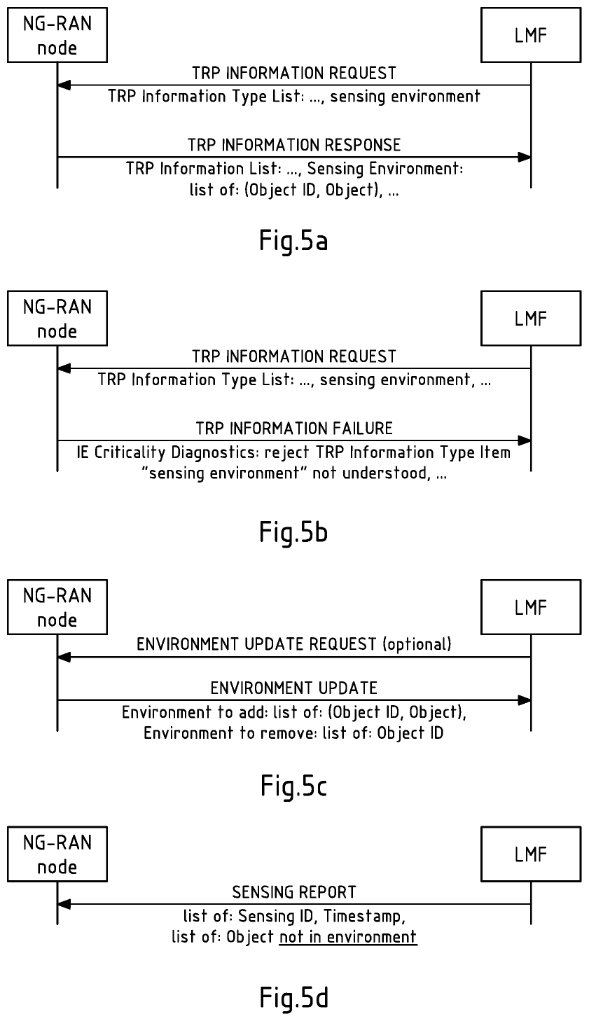

FIG. 5a-d each show a signaling flowchart showing an example embodiment of all exemplary aspects. In FIG. 5a-d, the NG-RAN node may for instance be represented by an apparatus according to the first exemplary aspect (e.g. respective SAPs). Further, in FIG. 5a-d, the LMF may for instance be represented by an apparatus according to the second exemplary aspect.

FIG. 5a shows an example embodiment of the respective methods according to the first and second exemplary aspect in which a central entity (e.g. the LMF) requests the (e.g. required) sensing environment information and the respective SAP(s) answers accordingly by providing the requested sensing environment information. In FIG. 5b, the respective SAP as the shown NG-RAN node did not implement this request and thus answers with a failure since it may not be configured for a providing of sensing environment information. In FIG. 5c, the possibility of the NG-RAN node (e.g. SAP) to be requested of certain sensing environment information to be updated is shown. In FIG. 5d, a general sensing report is provided (e.g. transferred) to the central entity (e.g. LMF) by the NG-RAN node e.g. informing the central entity that the respective NG-RAN node is (e.g. currently) not located in the environment for which the central entity may have requested sensing environment information. This may be done without the requirement of providing them in response to a request. However, e.g. by higher layer signaling, the NG-RAN node may have previously received a request e.g. for providing periodic sensing reports.

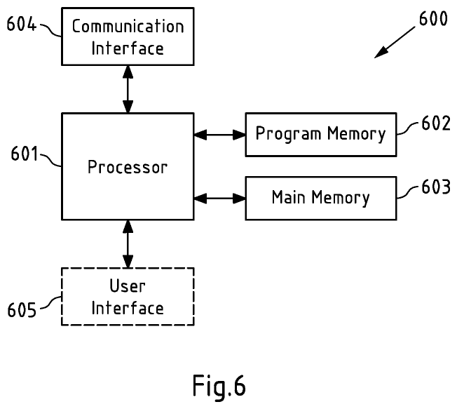

FIG. 6 is a schematic block diagram of an apparatus 600 according to an exemplary aspect, which may for instance represent one of the electronic devices 130-1a, 130-1b, 130-2a, 130-2b or 130-3 of FIG. 1.

Alternatively, the schematic block diagram of the apparatus 600 according to an exemplary aspect may for instance represent the apparatus 110 of FIG. 1.

Apparatus 600 comprises a processor 601, program memory 602, working or main memory 603, data memory, communication interface(s) 604, and an optional user interface 605.

Apparatus 600 may for instance be configured to perform and/or control or comprise respective means (at least one of 601 to 605) for performing and/or controlling the method according to the first and/or second exemplary aspect. Apparatus 600 may as well constitute an apparatus comprising at least one processor (601) and at least one memory (602) including computer program code, the at least one memory and the computer program code configured to, with the at least one processor, cause an apparatus, e.g. apparatus 600 at least to perform and/or control the method according to all exemplary aspects.

Processor 601 may for instance comprise a sensing capability information and/or sensing environment information gatherer as a functional and/or structural unit. Sensing capability information and/or sensing environment information gatherer may for instance be configured to gather at least one of sensing capability information or sensing environment information (see step 202 of FIG. 2).

Processor 601 may for instance comprise a sensing capability information and/or sensing environment information obtainer as a functional and/or structural unit. Sensing capability information and/or sensing environment information obtainer may for instance be configured to obtain at least one of (e.g. gathered) sensing capability information or sensing environment information (see step 302 of FIG. 3).

Processor 601 may for instance further control the memories 602 to 603, the communication interface(s) 604, the optional user interface 605.

Processor 601 may for instance execute computer program code stored in program memory 602, which may for instance represent a computer readable storage medium comprising program code that, when executed by processor 601, causes the processor 601 to perform the method according to the first and/or second exemplary aspect.

Processor 601 (and also any other processor mentioned in this specification) may be a processor of any suitable type. Processor 601 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 601 may for instance be an application processor that runs an operating system.

Program memory 602 may also be included into processor 601. This memory may for instance be fixedly connected to processor 601, or be at least partially removable from processor 601, for instance in the form of a memory card or stick. Program memory 602 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 602 may also comprise an operating system for processor 601. Program memory 602 may also comprise a firmware for apparatus 600.

Apparatus 600 comprises a working memory 603, for instance in the form of a volatile memory. It may for instance be a Random Access Memory (RAM) or Dynamic RAM (DRAM), to give but a few non-limiting examples. It may for instance be used by processor 601 when executing an operating system and/or computer program.

Data memory may for instance be a non-volatile memory. It may for instance be a FLASH memory (or a part thereof), any of a ROM, PROM, EPROM and EEPROM memory (or a part thereof) or a hard disc (or a part thereof), to name but a few examples. Data memory may for instance store one or more pieces of sensing capability information, one or more pieces of sensing environment information, one or more sensing operations, one or more pieces of assignments, or a combination thereof, to name but a few non-limiting examples.

Communication interface(s) 604 enable apparatus 600 to communicate with other entities, e.g. with apparats 110 of FIG. 1 in case apparatus 600 represent one of the electronic devices 130-1a, 130-1b, 130-2a, 130-2b or 130-3 of FIG. 1. Communication interface(s) 604 enable apparatus 600 to communicate with other entities, e.g. with one of the electronic devices 130-1a, 130-1b, 130-2a, 130-2b or 130-3 of FIG. 1 in case apparatus 600 represents apparats 110 of FIG. 1. The communication interface(s) 604 may for instance comprise a wireless interface, e.g. a cellular radio communication interface and/or a WLAN interface) and/or wire-bound interface, e.g. an IP-based interface, for instance to communicate with entities via the Internet. Communication interface(s) may enable apparatus 600 to communicate with other entities, for instance one or more entities as comprised by a mobile communication network, as disclosed above in the summary section.

User interface 605 is optional and may comprise a display for displaying information to a user and/or an input device (e.g. a keyboard, keypad, touchpad, mouse, etc.) for receiving information from a user.

Some or all of the components of the apparatus 600 may for instance be connected via a bus. Some or all of the components of the apparatus 600 may for instance be combined into one or more modules.

The following embodiments shall also be considered to be disclosed:

### Embodiment 1

A method comprising:
receiving a request for providing at least one of sensing capability information or sensing environment information, wherein the sensing capability information is indicative of one or more capabilities related to at least one transceiver, and wherein the sensing environment information is indicative of one or more properties of a radio environment;
gathering, based at least in part on the request, at least one of the sensing capability information or sensing environment information;
providing at least one of the gathered sensing capability information or sensing environment information towards a central entity of a mobile communication network; and
receiving an assignment for one or more sensing operations.

### Embodiment 2

The method according to embodiment 1, wherein the gathering of the sensing capability information further comprises at least one of:
determining at least one beam configuration; or
determining at least one synchronization available or active.

### Embodiment 3

The method according to embodiment 1 or embodiment 2, wherein the gathering of the sensing environment information further comprises at least one of:
determining at least one load level in its serving cell;
determining at least one interference level; or
determining scenario dependent information indicative of one or more dynamic properties.

### Embodiment 4

The method according to any of the preceding embodiments, wherein the request is or is part of a Transmission Reception Point, TRP, information request or an environment update request.

### Embodiment 5

The method according to any of the preceding embodiments, wherein at least one of the gathered sensing capability information or sensing environment information is provided via a Transmission Reception Point, TRP, information response.

### Embodiment 6

The method according to embodiment 4 or embodiment 5, wherein at least one of the TRP information request or the TRP information response is received or sent via ad-hoc messaging.

### Embodiment 7

The method according to any of the preceding embodiments, the method further comprising:
determining whether a sensing device supports the gathering of at least one of the sensing capability information or sensing environment information or not; and
in response to determining that the sensing device does not support the gathering of at least one of the sensing capability information or sensing environment information, providing a failure information.

### Embodiment 8

The method according to any of the preceding embodiments, wherein the request comprises, at least a part of it, at least one of the following fields associated with the sensing capability information (e.g. of the sensing device):
a panel identifier;
at least one of a respective panel position, orientation or rotation of at least one antenna panel;
a respective beamforming type supported;
a respective polarization supported;
a respective minimum azimuth value of at least one beam emittable;
a respective maximum azimuth value of at least one beam emittable;
a respective minimum elevation value of at least one at least one beam;
a respective maximum elevation value of at least one at least one beam emittable;
a respective beamwidth per beam emittable;
at least one of one or more supported carrier frequencies, modes of operation, or bandwidths supported;
one or more update rates of beam patterns;
a respective receiver sensitivity;
a respective power consumption value;
a available energy information; or
a synchronization confidence in one or more synchronizations available or active on part.

### Embodiment 9

The method according to any of the preceding embodiments, wherein the request comprises, at least a part of it, at least one of the following fields associated with the sensing environment information:
a respective availability of one or more resources;
a respective confidence of one or more detected reflectors;
one or more interference levels;
a respective blockage of a certain direction or beam;
a detected object information;
one or more environmental changes; or
a certain direction or range of one or more further devices for communication.

### Embodiment 10

The method according to any of the preceding embodiments, the method further comprising:
performing, based on the received assignment, the one or more sensing operations; and
providing information indicative of one or more results of at least one performed sensing operation of the one or more sensing operations.

### Embodiment 11

The method according to any of the preceding embodiments, wherein a respective assignment a respective assignment comprises at least one of a probing sensing operation, a responding to a probing sensing operation, an interworking with another sensing device probing operation.

### Embodiment 12

The method according to any of the preceding embodiments, wherein the method is performed and/or controlled by a radio access network, RAN, node of a mobile communication network, a sensing access point, SAP, or a user equipment, UE, supporting sensing.

### Embodiment 13

A method comprising:
sending a request for providing at least one of sensing capability information or sensing environment information, wherein the sensing capability information is indicative of one or more capabilities related to at least one transceiver of a sensing device, and wherein the sensing environment information is indicative of one or more properties of a radio environment of the sensing device;
obtaining at least one of the gathered sensing capability information or sensing environment information that were provided towards a central entity (e.g. performing this method);
determining an assignment of one or more sensing operations for the sensing device, wherein the assignment is determined based, at least in part, on the at least one of the gathered sensing capability information or sensing environment information; and
providing the determined assignment.

### Embodiment 14

The method according to embodiment 13, the method further comprising:
merging at least one of a plurality of pieces of sensing capability information or sensing environment information obtained from a plurality of sensing devices, wherein the assignment for a respective sensing device is determined further based on the merged at least one of one or more pieces of sensing capability information or sensing environment information.

### Embodiment 15

The method according to embodiment 13 or embodiment 14, wherein the request is or is part of a Transmission Reception Point, TRP, information request or an environment update request.

### Embodiment 16

The method according to any of the embodiment 13 to 15, wherein at least one of the sensing capability information or sensing environment information is obtained via a Transmission Reception Point, TRP, information response.

### Embodiment 17

The method according to embodiment 15 or embodiment 16, wherein at least one of the TRP information request or the TRP information response is sent or received via ad-hoc messaging.

### Embodiment 18

The method according to any of the embodiments 13 to 17, the method further comprising:
determining one or more sensing devices enabled to provide, at least partially jointly, at least one of one or more range estimates, angular estimates, speed estimates or object's shape estimates.

### Embodiment 19

The method according to any of the embodiments 13 to 18, the method further comprising:
obtaining information indicative of one or more results of at least one sensing operation performed by at least one sensing device.

### Embodiment 20

The method according to any of the embodiments 13 to 19, wherein the method is performed and/or controlled by a central entity of a mobile communication network.

### Embodiment 21

An apparatus, comprising means for:
receiving a request for providing at least one of sensing capability information or sensing environment information, wherein the sensing capability information is indicative of one or more capabilities related to at least one transceiver of the apparatus, and wherein the sensing environment information is indicative of one or more properties of a radio environment of the apparatus;
gathering, based at least in part on the request, at least one of the sensing capability information or sensing environment information;
providing at least one of the gathered sensing capability information or sensing environment information towards a central entity of a mobile communication network; and receiving an assignment for one or more sensing operations.

### Embodiment 22

The apparatus according to embodiment 21, wherein the gathering of the sensing capability information further comprises means for at least one of:
determining at least one beam configuration; or
determining at least one synchronization available or active at the apparatus.

### Embodiment 23

The apparatus according to embodiment 21 or embodiment 22, wherein the gathering of the sensing environment information further comprises means for at least one of:
determining at least one load level of the apparatus in its serving cell;
determining at least one interference level of the apparatus; or
determining scenario dependent information indicative of one or more dynamic properties to which the apparatus is subject.

### Embodiment 24

The apparatus according to any of the embodiments 21 to 23, wherein the request is or is part of a Transmission Reception Point, TRP, information request or an environment update request.

### Embodiment 25

The apparatus according to any of the embodiments 21 to 24, wherein at least one of the gathered sensing capability information or sensing environment information is provided via a Transmission Reception Point, TRP, information response.

### Embodiment 26

The apparatus according to embodiment 24 or embodiment 25, wherein at least one of the TRP information request or the TRP information response is received or sent via ad-hoc messaging.

### Embodiment 27

The apparatus according to any of the embodiments 21 to 26, further comprising means for:
determining whether the apparatus supports the gathering of at least one of the sensing capability information or sensing environment information or not; and in response to determining that the apparatus does not support the gathering of at least one of the sensing capability information or sensing environment information, providing a failure information.

### Embodiment 28

The apparatus according to any of the embodiments 21 to 27, wherein the request comprises, at least a part of it, at least one of the following fields associated with the sensing capability information:
a panel identifier of the apparatus;
at least one of a respective panel position, orientation or rotation of at least one antenna panel of the apparatus;
a respective beamforming type supported by the apparatus;
a respective polarization supported by the apparatus;
a respective minimum azimuth value of at least one beam emittable by the apparatus;
a respective maximum azimuth value of at least one beam emittable by the apparatus;
a respective minimum elevation value of at least one at least one beam emittable by the apparatus;
a respective maximum elevation value of at least one at least one beam emittable by the apparatus;
a respective beamwidth per beam emittable by the apparatus;
at least one of one or more supported carrier frequencies, modes of operation, or bandwidths supported by the apparatus;
one or more update rates of beam patterns;
a respective receiver sensitivity of the apparatus;
a respective power consumption value of the apparatus;
a available energy information of the apparatus; or
a synchronization confidence in one or more synchronizations available or active on part of the apparatus.

### Embodiment 29

The apparatus according to any of the preceding embodiments 21 to 28, wherein the request comprises, at least a part of it, at least one of the following fields associated with the sensing environment information:
a respective availability of one or more resources;
a respective confidence of one or more detected reflectors;
one or more interference levels;
a respective blockage of a certain direction or beam;
a detected object information;
one or more environmental changes; or
a certain direction or range of one or more further devices for communication.

### Embodiment 30

10. The apparatus according to any of the embodiments 21 to 29, further comprising means for:
performing, based on the received assignment, the one or more sensing operations; and providing information indicative of one or more results of at least one performed sensing operation of the one or more sensing operations.

### Embodiment 31

The apparatus according to any of the embodiments 21 to 30, wherein a respective assignment a respective assignment comprises at least one of a probing sensing operation, a responding to a probing sensing operation, an interworking with another sensing device probing operation.

### Embodiment 32

The apparatus according to any of the embodiments 21 to 31, wherein the apparatus is a radio access network, RAN, node of a mobile communication network, a sensing access point, SAP, or a user equipment, UE, supporting sensing.

### Embodiment 33

An apparatus, comprising means for:
sending a request for providing at least one of sensing capability information or sensing environment information, wherein the sensing capability information is indicative of one or more capabilities related to at least one transceiver of a sensing device, and wherein the sensing environment information is indicative of one or more properties of a radio environment of the sensing device;
obtaining at least one of the gathered sensing capability information or sensing environment information that were provided towards the apparatus;
determining an assignment of one or more sensing operations for the sensing device, wherein the assignment is determined based, at least in part, on the at least one of the gathered sensing capability information or sensing environment information; and
providing the determined assignment.

### Embodiment 34

The apparatus according to embodiment 33, further comprising means for:
merging at least one of a plurality of pieces of sensing capability information or sensing environment information obtained from a plurality of sensing devices, wherein the assignment for a respective sensing device is determined further based on the merged at least one of one or more pieces of sensing capability information or sensing environment information.

### Embodiment 35

The apparatus according to embodiment 33 or embodiment 34, wherein the request is or is part of a Transmission Reception Point, TRP, information request or an environment update request.

### Embodiment 36

The apparatus according to any of the embodiment 33 to 35, wherein at least one of the sensing capability information or sensing environment information is obtained via a Transmission Reception Point, TRP, information response.

### Embodiment 37

The apparatus according to embodiment 33 or embodiment 36, wherein at least one of the TRP information request or the TRP information response is sent or received via ad-hoc messaging.

### Embodiment 38

The apparatus according to any of the embodiments 33 to 37, further comprising means for:
determining one or more sensing devices enabled to provide, at least partially jointly, at least one of one or more range estimates, angular estimates, speed estimates or object's shape estimates.

### Embodiment 39

The apparatus according to any of the embodiments 33 to 38, further comprising means for:
obtaining information indicative of one or more results of at least one sensing operation performed by at least one sensing device.

### Embodiment 40

The apparatus according to any of the embodiments to 39, wherein the apparatus is a central entity of a mobile communication network.

### Embodiment 41

A system, comprising:
at least one apparatus of any of the embodiments 21 to 32; and
an apparatus of any of the embodiments 33 to 40.

### Embodiment 42

A computer readable medium comprising program instructions configured to perform and/or control or comprising respective means for performing and/or controlling the method of any of the embodiments 1 to 12.

### Embodiment 43

A computer readable medium comprising program instructions configured to perform and/or control or comprising respective means for performing and/or controlling the method of any of the embodiments 13 to 20.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are only exemplary, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of only one of the enumerated features is possible. The specific combination of all subsequently enumerated features may as well be considered. Also, a plurality of only one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The subject-matter has been described above by means of example embodiments. It should be noted that there are alternative ways and variations which are obvious to a skilled person in the art and can be implemented without deviating from the scope of the appended claims.

1-21. (canceled)

22. An apparatus comprising at least one processor and at least one memory including computer program code, the at least one memory and the computer program code configured to, with the at least one processor, cause the apparatus to at least perform:
receiving a request for providing at least one of sensing capability information or sensing environment information, wherein the sensing capability information is indicative of one or more capabilities related to at least one transceiver of the apparatus, and wherein the sensing environment information is indicative of one or more properties of a radio environment of the apparatus;
gathering, based at least in part on the request, at least one of the sensing capability information or sensing environment information;
providing at least one of the gathered sensing capability information or sensing environment information towards a central entity of a mobile communication network; and
receiving an assignment for one or more sensing operations.

23. The apparatus according to claim 22, wherein the gathering of the sensing capability information further comprises at least one of:
determining at least one beam configuration; or
determining at least one synchronization available or active at the apparatus.

24. The apparatus according to claim 22, wherein the gathering of the sensing environment information further comprises at least one of:
determining at least one load level of the apparatus in its serving cell;
determining at least one interference level of the apparatus; or
determining scenario dependent information indicative of one or more dynamic properties to which the apparatus is subject.

25. The apparatus according to claim 22, wherein the request is or is part of a Transmission Reception Point, TRP, information request or an environment update request.

26. The apparatus according to claim 22, wherein at least one of the gathered sensing capability information or sensing environment information is provided via a Transmission Reception Point, TRP, information response.

27. The apparatus according to claim 22, wherein at least one of the TRP information request or the TRP information response is received or sent via ad-hoc messaging.

28. The apparatus according to claim 22, wherein the at least one memory and the computer program code configured to, with the at least one processor, cause the apparatus further to perform:
determining whether the apparatus supports the gathering of at least one of the sensing capability information or sensing environment information or not; and
in response to determining that the apparatus does not support the gathering of at least one of the sensing capability information or sensing environment information, providing a failure information.

29. The apparatus according to claim 22, wherein the request comprises, at least a part of it, at least one of the following fields associated with the sensing capability information:
a panel identifier of the apparatus;
at least one of a respective panel position, orientation or rotation of at least one antenna panel of the apparatus;
a respective beamforming type supported by the apparatus;
a respective polarization supported by the apparatus;
a respective minimum azimuth value of at least one beam emittable by the apparatus;
a respective maximum azimuth value of at least one beam emittable by the apparatus;
a respective minimum elevation value of at least one at least one beam emittable by the apparatus;
a respective maximum elevation value of at least one at least one beam emittable by the apparatus;
a respective beamwidth per beam emittable by the apparatus;
at least one of one or more supported carrier frequencies, modes of operation, or bandwidths supported by the apparatus;
one or more update rates of beam patterns;
a respective receiver sensitivity of the apparatus;
a respective power consumption value of the apparatus;
a available energy information of the apparatus; or
a synchronization confidence in one or more synchronizations available or active on part of the apparatus.

30. The apparatus according to claim 22, wherein the request comprises, at least a part of it, at least one of the following fields associated with the sensing environment information:
a respective availability of one or more resources;
a respective confidence of one or more detected reflectors;
one or more interference levels;
a respective blockage of a certain direction or beam;
a detected object information;
one or more environmental changes; or
a certain direction or range of one or more further devices for communication.

31. The apparatus according to claim 22, wherein the at least one memory and the computer program code configured to, with the at least one processor, cause the apparatus further to perform:
performing, based on the received assignment, the one or more sensing operations; and
providing information indicative of one or more results of at least one performed sensing operation of the one or more sensing operations.

32. The apparatus according to claim 22, wherein a respective assignment comprises at least one of a probing sensing operation, a responding to a probing sensing operation, an interworking with another sensing device probing operation.

33. The apparatus according to claim 22, wherein the apparatus is a radio access network, RAN, node of a mobile communication network, a sensing access point, SAP, or a user equipment, UE, supporting sensing.

34. An apparatus comprising at least one processor and at least one memory including computer program code, the at least one memory and the computer program code configured to, with the at least one processor, cause the apparatus to at least perform:
sending a request for providing at least one of sensing capability information or sensing environment information, wherein the sensing capability information is indicative of one or more capabilities related to at least one transceiver of a sensing device, and wherein the sensing environment information is indicative of one or more properties of a radio environment of the sensing device;
obtaining at least one of the gathered sensing capability information or sensing environment information that were provided towards the apparatus;
determining an assignment of one or more sensing operations for the sensing device, wherein the assignment is determined based, at least in part, on the at least one of the gathered sensing capability information or sensing environment information; and
providing the determined assignment.

35. The apparatus of claim 34, wherein the at least one memory and the computer program code configured to, with the at least one processor, cause the apparatus further to perform:
merging at least one of a plurality of pieces of sensing capability information or sensing environment information obtained from a plurality of sensing devices,
wherein the assignment for a respective sensing device is determined further based on the merged at least one of one or more pieces of sensing capability information or sensing environment information.

36. The apparatus of claim 34, wherein the request is or is part of a Transmission Reception Point, TRP, information request or an environment update request.

37. The apparatus of claim 34, wherein at least one of the sensing capability information or sensing environment information is obtained via a Transmission Reception Point, TRP, information response.

38. The apparatus of claim 36, wherein at least one of the TRP information request or the TRP information response is sent or received via ad-hoc messaging.

39. The apparatus of claim 34, wherein the at least one memory and the computer program code configured to, with the at least one processor, cause the apparatus further to perform:
determining one or more sensing devices enabled to provide, at least partially jointly, at least one of one or more range estimates, angular estimates, speed estimates or object's shape estimates.

40. The apparatus of claim 34, wherein the at least one memory and the computer program code configured to, with the at least one processor, cause the apparatus further to perform:
obtaining information indicative of one or more results of at least one sensing operation performed by at least one sensing device.

41. The apparatus of claim 34, wherein the apparatus is a central entity of a mobile communication network.
